(19) United States
(12) Patent Application Publication
(10) Pub. No.: US 2024/0400352 A1
(43) Pub. Date: Dec. 5, 2024

(54) JIB CRANE CART ASSEMBLY

(71) Applicant: VANOCUR REFRACTORIES LLC, TONAWANDA, NY (US)

(72) Inventors: Paul A. Saffrin, Tonawanda, NY (US); Richard M. Maida, Tonawanda, NY (US)

(21) Appl. No.: 18/701,507

(22) PCT Filed: Oct. 13, 2022
(86) PCT No.: PCT/US2022/078043

§ 371 Date: Apr. 15, 2024

Related U.S. Application Data
(60) Provisional application No. 63/262,572, filed on Oct. 15, 2021.

(51) Int. Cl. B66C 23/48

(52) U.S. Cl. CPC B66C 23/48

(57) ABSTRACT

A jib crane cart assembly including a platform having a proximal surface and a distal surface, the platform having a reinforcement structure between the proximal surface and the distal surface, a pair of masts extending from the proximal surface of the platform, each of the masts having a jib arm moveably secured thereto, and a set of wheels secured to the platform, wherein the set of wheels are arranged for a cart track of a coke oven battery.

### CROSS-REFERENCE TO RELATED APPLICATIONS

This application claims the benefit under Articles 4 and 8 of the Stockholm Act of the Paris Convention for the Protection of Industrial Property of U.S. Provisional Application No. 63/262,572, filed Oct. 15, 2021, which application is hereby incorporated by reference herein in its entirety.

### FIELD

The present invention relates to crane assemblies, and more particularly, to jib crane assemblies utilized for the construction and demolition of coke ovens.

### BACKGROUND

Lifting devices, also known as lifting gear, is a general term for any equipment that can be used to lift and lower loads. In one example of a lifting device, a jib or a jib arm is the horizontal or near-horizontal beam used in many types of cranes to support the load clear of the main support. Usually, jib arms are attached to a vertical mast or tower or sometimes to an inclined boom. In other jib-less designs such as derricks, the load is hung directly from a boom which is often anomalously called a jib. Lifting devices are utilized to construct and demolish a coke oven battery, which is used to produce coke by heating coal. This battery may have anywhere from 40 to 100 side-by-side coking chambers or ovens separated from each other by heating walls.

However, current lifting devices do not have the capacity to span the entirety of the coke oven battery, given its enormous size. Thus, lifting devices must be deconstructed and moved and reconstructed to construct/demolish a different portion of the coke oven battery. This is time consuming and costly. Additionally, lifting devices that are transportable extend from the ground level and must be maneuvered around the perimeter of the coke oven battery, which is very often difficult given the close proximity of the coke oven battery to other structures on a campus.

In many coke oven battery designs, there are preinstalled rails in which vehicles, called Larry carts, travel along in order to transport coal from a storage bunker to each individual coke oven of the coke oven battery.

Thus, there is a long felt need for a jib crane cart assembly that can be used to construct and demolish coke oven batteries and is easily maneuverable thereabout.

There is another long felt need for a jib crane cart assembly that is arranged to be used with preexisting rails on the coke oven battery.

There is also a long felt need for a jib crane art assembly that is arranged to support the weight of an individual, or multiple, component pieces (blocks and/or bricks) for coke oven battery construction.

### SUMMARY

According to aspects illustrated herein, the present invention provides for a jib crane cart assembly. The jib crane cart assembly including a platform having a proximal surface and a distal surface, the platform having a reinforcement structure between the proximal surface and the distal surface, a pair of masts extending from the proximal surface of the platform, each of the masts have a jib arm moveably secured thereto, and a set of wheels secured to said platform. Where the set of wheels are arranged for a cart track of a coke oven battery, specifically, for a Larry cart track.

In some embodiments, the reinforcement structure of the jib crane cart assembly further includes a plurality of connected outer members, and a plurality of inner members, some of the plurality of inner members are connected to some of the plurality of outer members and some of the plurality of inner members are connected to some of the plurality of inner members. The platform of the jib crane cart assembly may also include at least one counterweight secured to said proximal surface of said platform.

In some embodiments, the jib crane cart assembly of the present invention may comprise a platform having a proximal surface and a distal surface, the platform having a reinforcement structure between the proximal surface and the distal surface, the reinforcement structure includes a plurality of connected outer members, and a plurality of inner members, where some of the plurality of inner members are connected to some of the plurality of outer members and where some of the plurality of inner members are connected to some of the plurality of inner members, at least one mast extending from the proximal surface of the platform, the mast having a jib arm moveably secured thereto, and a set of wheels secured to the platform, wherein the set of wheels are arranged for a cart track of a coke oven battery.

In some embodiments, the first mast is arranged perpendicular to the first side beam. In some embodiments, the intermediate beam is arranged between and spaced apart from the front beam and the rear beam. In some embodiments, the jib crane cart assembly further comprises at least one support beam extending from the first mast to the frame. In some embodiments, the at least one support beam comprises a first support beam extending from the mast to the first side beam, and a second support beam extending from the mast to the intermediate beam. In some embodiments, the first jib arm assembly comprises a connecting beam rotatably connected to the mast, and an arm fixedly secured to the connecting beam. In some embodiments, the arm is perpendicular to the connecting beam. In some embodiments, the arm comprises a first end connected to the connecting beam, the first end including a first stop arranged proximate thereto, and a second end including a second stop arranged proximate thereto. In some embodiments, the connecting beam is connected to the mast via a plurality of hinges.

In some embodiments, the jib crane cart assembly further comprises a second mast connected to a top surface of the second side beam. In some embodiments, the jib crane cart assembly further comprises a second jib arm assembly rotatably connected to the second mast. In some embodiments, the jib crane cart assembly further comprises a plurality of wheels rotatably connected to a bottom surface of the frame. In some embodiments, the plurality of wheels comprises a first wheel including a first flange, and a second wheel including a second flange, the second flange being unaligned with the first flange. In some embodiments, the jib crane cart assembly further comprises a hoist arranged on and being axially displaceable with respect to the jib arm assembly.

It should be appreciated that the various embodiments of the jib crane cart discussed herein provides for a crane assembly that is usable on existing Larry cart rails, includes a reinforcement structure allowing the crane assembly and the respective masts and jib arm assemblies to accommodate two-ton coke oven blocks and/or bricks, and the crane assembly also includes a counterweight to prevent the assembly from displacing from the Larry cart rails when individual blocks and/or bricks are displaced from a platform of the crane assembly via the respective masts and jib arm assemblies.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is generally a perspective view of an embodiment of a coke oven battery;

FIG. 2 is a perspective view of a jib crane cart assembly in use;

FIG. 3 is a perspective exploded view of the invention shown in FIG. 2;

FIG. 4 is a perspective exploded view of platform 200, wheel set 300, flooring 400, and flooring with counterweight 450 of the invention shown in FIG. 2;

FIG. 5 is a perspective exploded view of first mast 500 and jib arm 550 of the invention shown in FIG. 2;

FIG. 6 is a perspective view of jib crane cart assembly 100 moving block 800; and,

FIG. 7 is a right-side view of jib crane cart assembly 100 moving block 800.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

By “non-rotatably connected” elements, it is meant that: the elements are connected so that whenever one of the elements rotate, all the elements rotate; and relative rotation between the elements is not possible. Radial and/or axial movement of non-rotatably connected elements with respect to each other is possible, but not required. By “rotatably connected” elements, it is meant that: the elements are rotatable with respect to each other.

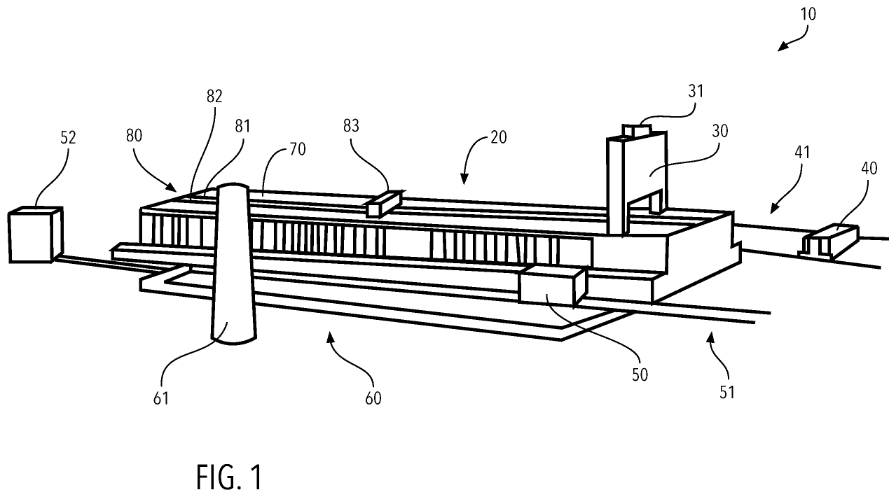

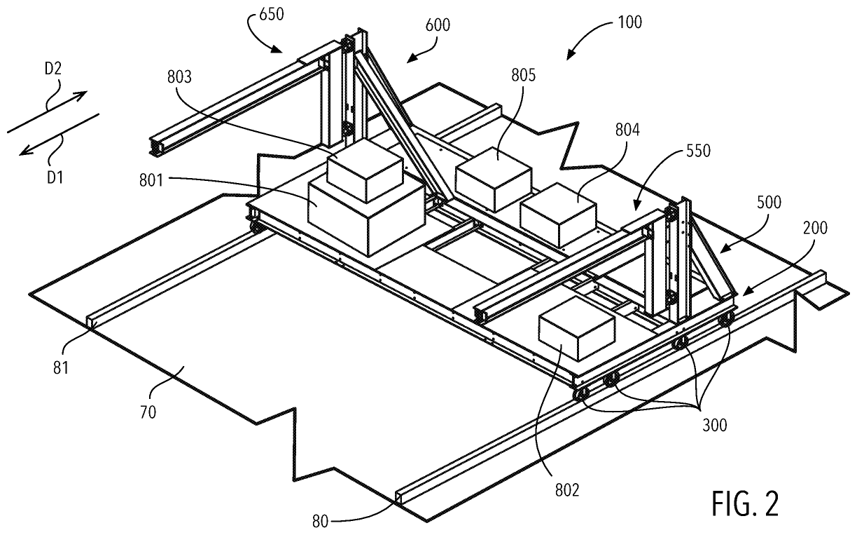

Adverting now to the figures, FIG. 1 illustrates a general embodiment of a coke oven battery and facility where the present invention is preferably employed. Coke factory 10 generally includes coke oven battery 20 which comprises a plurality of individual coke ovens separated by a heat wall. Alongside and generally adjacent to coke oven battery 20 is pusher track 41 having pusher 40 thereon. Pusher 40 is arranged to move along pusher track 41. Pusher 40 is arranged to push coke within an individual coke oven of coke oven battery 20 from the side proximate to pusher track 41, through the individual oven, out of the individual oven to the side proximate to quench car track 51, disposed on the opposite side of coke oven battery 20. Quench car 50 is arranged to move along quench car track 51 to transport the coke to quench tower 52; the coke is received by quench car 50 via the pushing from coke oven battery 20 by pusher 40. Quench tower 52 is arranged to cool coke that is received from an oven on quench car 50. Arranged on top 70 of coke oven battery 20 is coal bunker 30 and coal conveyor 31. Coal bunker 30 generally stores coal that is arranged to be fed into the individual ovens of coke oven battery 20. Coke wharf 60 is generally arranged on one side of coke oven battery 20 and is generally the designated area where coke is loaded or unloaded. Also shown on the side of coke oven battery 20 is combustion stack 61 which serves as an exhaust as a result of the fuel that is combusted to produce heat for coke oven battery 20. It should be appreciated that coke factory 10 shown in FIG. 1 is merely exemplary and various other designs and combinations are contemplated for the use of jib crane cart assembly 100 (shown in FIG. 2) described herein.

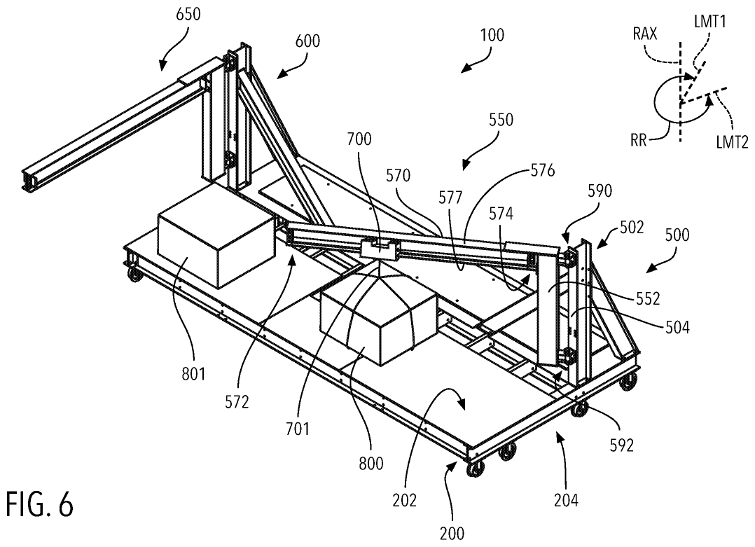

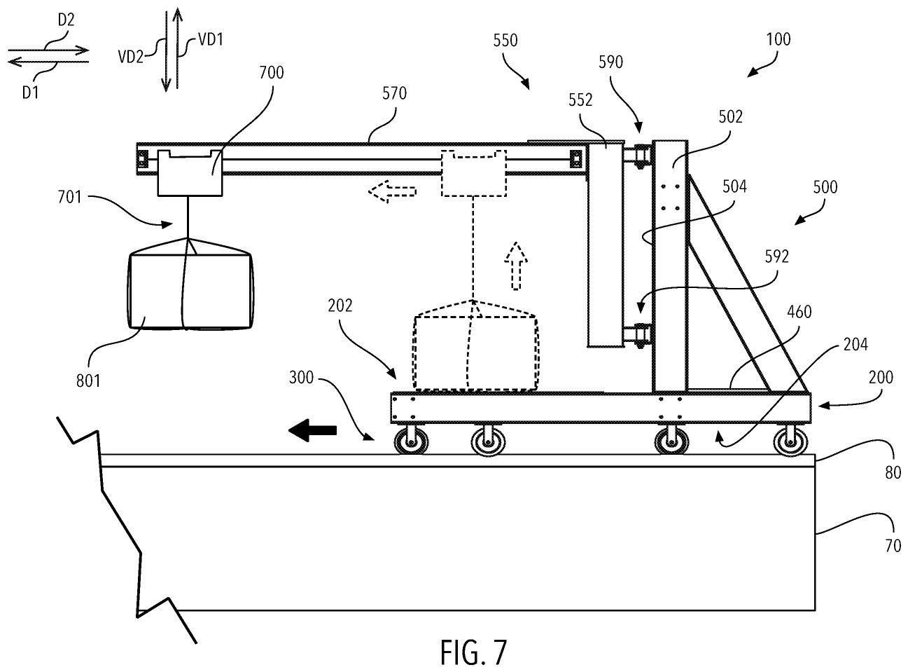

The following description should be taken in view of FIGS. 1 and 2. FIG. 2 illustrates jib crane cart assembly 100 in use, specifically assembly 100 is engaged on Larry cart track 80 of top of coke oven 70 (a section of top 70 and Larry cart track 80 is generally illustrated in FIG. 2), where Larry cart track 80 includes rail 81 and rail 82. (It is well known in the art that a pulverized coal mixture is introduced into coke ovens, or “charged,” by a “Larry car” or a “Larry cart”, Larry cart 83 in FIG. 1. Larry cart 83 is akin to a railcar that moves across a track that runs along the top of a coke oven battery.) Each individual oven has a “charging port,” a door with a lid, that is removed when larry car 83 is positioned above the oven in order for the pulverized coal to be charged. Although assembly 100 is shown on Larry cart track 80, it should be appreciated that assembly 100 could be used on a variety of different rail tracks outside of a coke oven, alternatively, assembly 100 could be used on quench car track 51 or pusher track 41 (shown in FIG. 1). Assembly 100 engages Larry cart track 80 via wheel set 300 disposed on platform 200. Platform 200 is arranged to hold a plurality of coke oven blocks or bricks for construction or deconstruction, blocks 801-805, thereon. First mast 500 and second mast 600 extend from platform 200 and have jib arms 550 and 650, respectively. Jib arms 550 and 650 of first mast 500 and second mast 600 are preferably arranged with a hoist (shown in FIGS. 6 and 7, discussed further infra) and may rotate to move blocks 801-805 onto, and off of, platform 200 with the assistance of a hoist arranged on each of jib arms 550 and 650.

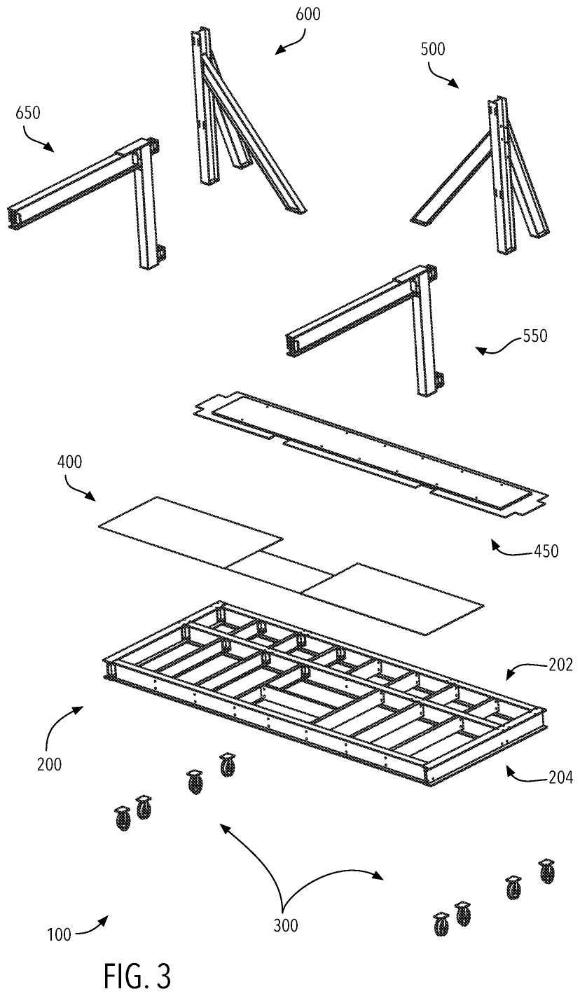

FIG. 3 is an exploded perspective view of jib crane cart assembly 100. Assembly 100 generally includes platform 200 having proximal surface 202 and distal surface 204, wheel set 300, flooring 400, flooring with counterweight 450, first mast 500 having jib arm 550 arranged to be movably secured thereto, and second mast 600 having jib arm 650 arranged to be movably secured thereto. Wheel set 300 comprises a plurality of wheels having attachment means. Each of the attachment means of each wheel of wheel set 300 are arranged to be secured to distal surface 204 of platform 200. Flooring 400 and flooring with counterweight 450 are arranged to be secured to proximal surface 202 of platform 200. First mast 500 having jib arm 550 is arranged to be secured to proximal surface 202 of platform 200. Second mast 600 having jib arm 650 is arranged to be secured to proximal surface 202 of platform 200.

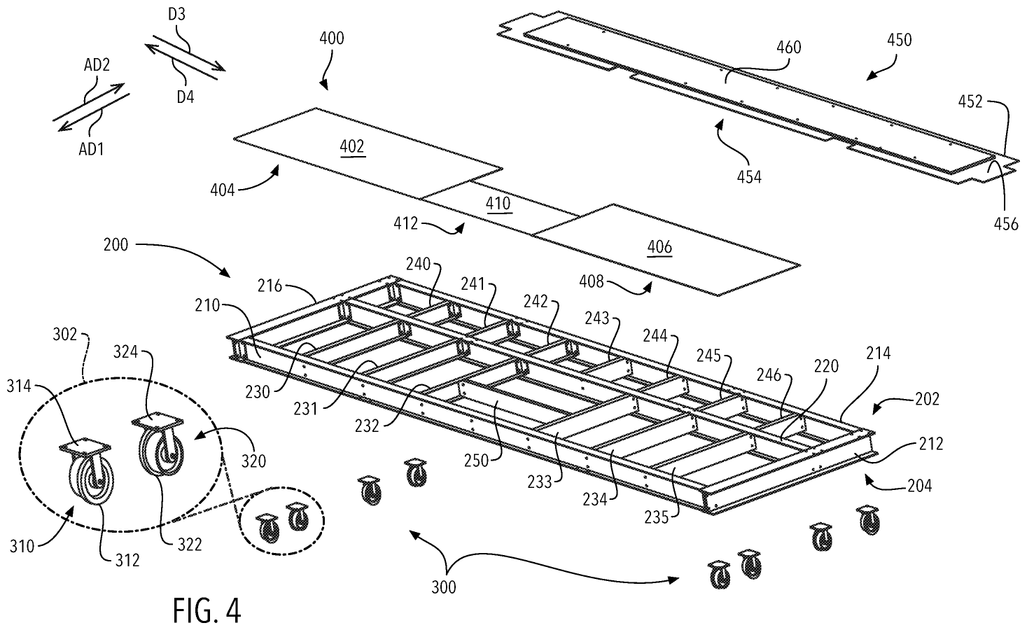

FIG. 4 is a perspective exploded view of platform 200, wheel set 300, flooring 400, and flooring with counterweight 450. Platform 200 is formed by interconnected outer members 210, 212, 214, and 216. Transverse member 220 is an inner member of platform 200 and is connected to and disposed between outer members 212 and 216. First through sixth inner members 230-235 are connected to and disposed between outer member 210 and transverse member 220. Seventh through thirteenth inner members 240-246 are connected to and disposed between outer member 214 and transverse member 220. Fourteenth inner member 250 is connected to and disposed between third inner member 232 and fourth inner member 233. In a preferred embodiment, the outer members, inner members, and transverse member are aluminum I-beams, which may be secured via brackets or welding. It should be appreciated that the outer members, inner members, and transverse member may be alternatively constructed of other metal materials, such as steel. First through sixth inner members 230-235, transverse member 220, seventh through thirteenth inner members 240-246, and fourteenth inner member 250 collectively form a reinforcement structure disposed between outer members 210, 212, 214, and 216. It should be noted that although the reinforcement structure is illustrated in a substantially grid-like configuration, alternative configurations may be contemplated, such as a diagonal-like cross structure of the inner members connecting to a respective outer member and the transverse member. The reinforcement structure allows platform 200 to sustain a substantial weight loaded thereon, e.g., at least 4000 lbs., or 2 U.S. tons.

Flooring 400 in some embodiments may comprise first panel 402, second panel 406, and third panel 410. Flooring with counterweight 450 in some embodiments may comprise fourth panel 452 and counterweight 460. First panel 402, second panel 406, and third panel 410 all include attachment surfaces 404, 408, and 412, respectively, arranged on their respective bottom surfaces. Attachment surfaces 404, 408, and 412 are arranged to be secured to proximal surface 202 of platform 200. Fourth panel 450 includes attachment surface 454 and upper surface 456. Preferably, counterweight 460 is arranged on and secured to upper surface 456. Attachment surface 454 is arranged to be secured to proximal surface 202 of platform 200. Floorings 400 and 450 collectively provide for a surface arranged to hold coke oven blocks or bricks thereon, where flooring 450 provides a counterweight (460) such that the blocks or bricks disposed on flooring 400 will not tip platform 200, disengage wheel set 300 from its respective rail track in use, and/or the same, when blocks or bricks are moved by masts 500 and/or 600 (as shown in FIG. 1). The 20) panels (402, 406, 410, 452) are preferably diamond tread aluminum plates (corrosion-resistant, commercial grade), however it should be appreciated that, alternatively, a plurality of different metals could be used such as stainless steel, iron, etc. Counterweight 460 could take a variety of forms, e.g., a block(s), sheet, etc., and could also be comprised of a plurality of materials, e.g., lead, steel, heavy metals, etc.

Wheel set 300 in some embodiments may have eight (8) individual wheels with their respective attachment means, where each wheel of wheel set 300 is arranged to be secured to distal surface 204 of platform 200, and, more preferably, to the distal surface of outer members 212 and 216. As discussed supra, wheel set 300 is operatively arranged to engage a Larry cart rail (80 and 81, as shown in FIG. 2) such that jib crane cart assembly 100 can be rolled therealong. In such embodiments, wheel set 300 comprises a complementary pair of wheels 302 comprising 30 wheel 310 and wheel 320, where in the shown embodiment, wheel set 300 comprises four (4) pairs of these complementary pairs. Each of wheels 310 and 320 include attachment brackets 314 and 324, respectively, which are arranged to rotatably secure the respective wheel thereto and engage the respective wheel to distal surface 204 of platform 200. Wheels 310 and 320 each comprise a flange, flanges 312 and 322, respectively, where flanges 312 and 322 are arranged on different sides on alternating wheels of complementary pair of wheels 302. This arrangement prevents jib crane cart assembly 100 from falling off the rail. Essentially, the staggered arrangement of flanges 312 and 322 on adjacent wheels 310 and 320 engages each side of the rail, thereby permitting jib crane cart assembly 100 to be displaceable in first axial direction AD1 and second axial direction AD2, but not in a direction perpendicular thereto (i.e., direction parallel to the axis of wheels 312 and 322—directions D3 and D4). The rail discussed herein, shown in FIG. 1, is typically arranged (or can be arranged) on top of a coke oven battery (shown in FIG. 1) such that jib crane cart assembly 100 can be slid therealong (shown in FIG. 2). The easy slidability, or displacement, of jib crane cart assembly 100 along the track (preferably Larry cart track 80, or alternatively, pusher track 41 or quench car track 51—as shown in FIG. 1) on top of the coke oven battery allows for fast and easy construction and demolition of the coke oven battery, i.e., quick and efficient transportation of blocks or bricks for replacement or removal.

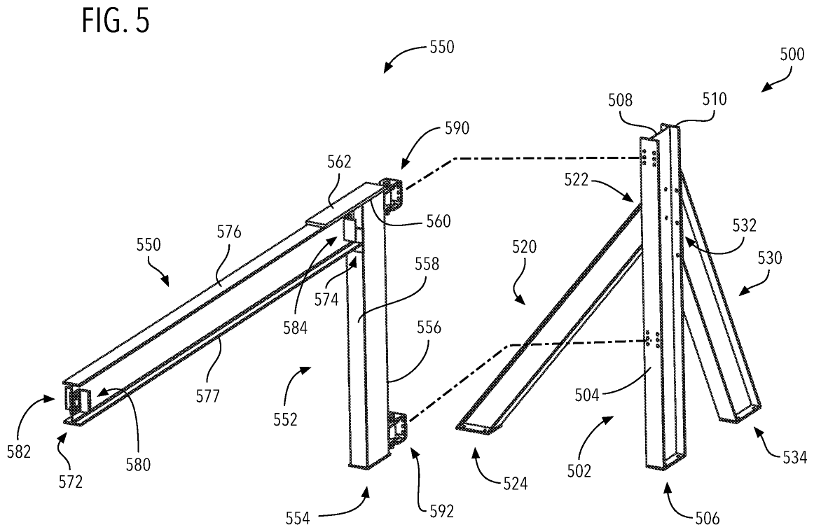

FIG. 5 is a perspective exploded view of first mast 500 and jib arm 550. It should be appreciated that the following description also applies to second mast 600 and jib arm 650, such that “500” series reference numerals correspond to “600” series components that are also present on second mast 600 and jib arm 650.

First mast 500 generally comprises main beam 502, first support beam 520, and second support beam 530. Main beam 502 includes attachment surface 504, mounting surface 506, side surface 508, and rear surface 510. First support beam 520 includes attachment surface 522 and mounting surface 524. Second support beam 530 includes attachment surface 532 and mounting surface 532. Attachment surface 522 of first support beam 520 is arranged to be connected to side surface 508 of main beam 502, via welding or attachment means, such as bolts, etc. Attachment surface 532 of second support beam 530 is arranged to be connected to rear surface 510 of main beam 502, via welding or attachment means, such as bolts, etc. When first mast 500 is assembled, mounting surfaces 506, 524, and 534 of main beam 502, first support beam 520, and second support beam 530, respectively, are arranged to be connected to proximal surface 202 of platform 200 (shown in FIG. 3). Main beam 502, first support beam 520, and second support beam 530 are preferably steel I-beams, however it should be appreciated that other materials may be used, e.g., aluminum, etc.

Jib arm 550 of first mast 500 generally comprises support arm 552, and extension arm 570. Support arm 552 includes lower end 554, rear surface 556, front surface 558, upper end 560, and connection plate 562 extending from and connected to upper end 560. Extension arm 570 is connected to support arm 552 on front surface 558. Extension arm 570 includes distal end 572, proximal end 574, upper surface 576, and a plurality of brackets, 580, 582, and 584 (it should be appreciated there is another bracket disposed on the opposite side of extension arm in relation to bracket 584). The plurality of brackets is operatively arranged to limit the movement of a hoist movably attached to extension arm 570 (shown in FIG. 6). Connection plate 562 is fixedly secured to upper end 560 of support arm and to upper surface 576 of extension arm 570 via welding or attachment means, such as bolts. Support arm 552 and extension arm 570 may be steel I-beams, however it should be appreciated that other materials may be used, e.g., aluminum, etc. Support arm 552 and extension arm 570 may be constructed of any material suitable to hold at least 3000 lbs. that would be disposed distally from and proximate to distal end 572 of extension arm.

In some embodiments, jib arm 550 is movably connected to first mast 500 via hinges 590 and 592, connected to rear surface 556 of support arm 552 and attachment surface 504 of main beam 502—allowing jib arm 550 to pivot thereabout, i.e., jib arm 550 and first mast 500 are rotatably connected.

The following description should be taken in view of FIGS. 6 and 7, whereas FIG. 6 generally illustrates a perspective view of jib crane cart assembly 100 moving block 800; and FIG. 7 generally illustrates a right-side view of the same. It should be appreciated that the following description, although in reference to jib arm 550, is also applicable to jib arm 650. In a preferred embodiment, jib arm 550 (and jib arm 650) are arranged to accept hoist 700 slidably, movably, etc., thereon. Hoist 700 may be arranged on either upper surface 576 or lower surface 577 of extension arm 570—in a manner where hoist 700 may move anywhere along extension arm 570 between distal end 572 and proximal end 574. Hoist 700 may be any apparatus that is capable of lifting coke oven blocks 800 and 801, i.e., capable of lifting and suspending a weight of at least 4000 lbs., or 2 U.S. tons. Hoist 700 includes suspension means 701 connected thereto, which may be any manner of lines, chain, rope, which is displaceable in the vertical directions (up and down) and is capable of securing and suspending coke oven blocks 800 and 801, i.e., capable of securing and suspending at least 4000 lbs., or 2 U.S. tons.

Hinges 590 and 592 allow support arm 552 to move in rotational range RR about rotational axis RAX, where rotational range RR is limited by limits LMT1 and LMT2 created by attachment surface 504 of main beam 502. It should be noted that this example is merely exemplary and nonlimiting on the appending claims.

When hoist 700 displaces coke oven block 800 away from platform 200 (as shown in FIG. 7), in direction D1, counterweight 460 prevents assembly 100 from tipping over, or displacing wheel set 300 from the Larry cart rails (rail 80 is shown in FIG. 7, where rails 80 and 81 are shown in FIG. 2).

In some embodiments attachment surface 504 of main beam 502 may be arranged with means to allow attachment surface 504 to move in vertical directions VD1 and VD2, thereby moving hinges 590 and 592 and jib arm 550 in vertical directions VD1 and VD2, respectively.

As discussed supra, wheel set 300 allows assembly 100 to move along rail 80 in directions D1 and D2. It should also be appreciated that in some embodiments, wheel set 300 may be motorized.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Coke factory
20 Coke oven battery
30 Coal bunker
31 Coal conveyor
40 Pusher
41 Pusher track
50 Quench Car
51 Quench car track
52 Quench tower
60 Coke wharf
61 Combustion stack
70 Top of coke oven battery
80 Larry cart rail track
81 Rail of Larry cart rail track 80
82 Rail of Larry cart rail track 80
83 Larry cart
100 Jib crane cart assembly
200 Platform
202 Proximal surface of platform 200
204 Distal surface of platform 200
210 First outer member
212 Second outer member
214 Third outer member
216 Fourth outer member
220 Transverse inner member
230 First inner member
231 Second inner members
232 Third inner member
233 Fourth inner member
234 Fifth inner member
235 Sixth inner member
240 Seventh inner member
241 Eighth inner member
242 Ninth inner member
243 Tenth inner member
244 Eleventh inner member
245 Twelfth inner member
246 Thirteenth inner member
250 Fourteenth inner member
300 Wheel set
302 Complementary pair of wheels of wheel set 300
310 First wheel of complementary pair of wheels 302
312 Flange of first wheel 310
314 Attachment bracket of first wheel 310
320 Second wheel of complementary pair of wheels 302
322 Flange of second wheel 320
324 Attachment bracket of second wheel 320
400 Flooring
402 First panel
404 Attachment surface of first panel 402
406 Second panel
408 Attachment surface of second panel 406
410 Third panel
412 Attachment surface of third panel 410
450 Flooring with counterweight
452 Fourth panel
454 Attachment surface of fourth panel 452
456 Upper surface of fourth panel 452
460 Counterweight
500 First mast
502 Main beam
504 Attachment surface of main beam 502
506 Mounting surface of main beam 502
508 Side surface of main beam 502
510 Rear surface of main beam 502
520 First support beam
522 Attachment surface of first support beam 520
524 Mounting surface of first support beam 520
530 Second support beam
532 Attachment surface of second support beam 530
534 Mounting surface of second support beam 530
550 Jib arm of first mast 500
552 Support arm of jib arm 550
554 Lower end of support arm 552
556 Rear surface of support arm 552
558 Front surface of support arm 552
560 Upper end of support arm 552
562 Connecting plate
570 Extension arm of jib arm 550
572 Distal end of extension arm 570
574 Proximal end of extension arm 570
576 Upper surface of extension arm 570
577 Lower surface of extension arm 570
580 Bracket of extension arm 570
582 Bracket of extension arm 570
584 Bracket of extension arm 570
600 Second mast
650 Jib arm of second mast 600
800 Coke oven block
801 Coke oven block
802 Coke oven block
803 Coke oven block
804 Coke oven block
805 Coke oven block
AD1 Axial direction
AD2 Axial direction
D1 First direction
D2 Second direction
D3 Third direction
D4 Fourth direction
LMT1 First limit
LMT2 Second limit
RAX Rotational axis
RR Rotational range
VD1 First vertical direction
VD2 Second vertical direction

What is claimed is:

1. A jib crane cart assembly, comprising:
a platform having a proximal surface and a distal surface, said platform having a reinforcement structure between said proximal surface and said distal surface;
a pair of masts extending from said proximal surface of said platform, each of said masts have a jib arm moveably secured thereto; and,
a set of wheels secured to said platform.

2. The jib crane cart assembly recited in claim 1, wherein said set of wheels are arranged for a cart track of a coke oven battery.

3. The jib crane cart assembly recited in claim 1, wherein each mast is supported by a supporting member extending from said platform.

4. The jib crane cart assembly recited in claim 1, wherein said reinforcement structure further includes:
a plurality of connected outer members; and,
a plurality of inner members, some of said plurality of inner members are connected to some of said plurality of outer members and some of said plurality of inner members are connected to some of said plurality of inner members.

5. The jib crane cart assembly recited in claim 2, wherein some wheels of said set of wheels includes a first flange and some wheels of said set of wheels include a second flange, said second flange being unaligned with said first flange, wherein said first flanges and said second flanges are arranged to contact said cart track.

6. The jib crane cart assembly recited in claim 1, wherein said each jib arm includes a hoist displaceably attached thereto.

7. The jib crane cart assembly recited in claim 4, wherein said proximal surface of said platform includes at least one floor member arranged thereon.

8. The jib crane cart assembly recited in claim 1, wherein each of said jib arms are hingedly connected to each of said pair of masts.

9. The jib crane cart assembly recited in claim 1 further comprising at least one counterweight secured to said proximal surface of said platform.

10. A jib crane cart assembly, comprising:
a platform having a proximal surface and a distal surface, said platform having a reinforcement structure between said proximal surface and said distal surface, said reinforcement structure includes:
a plurality of connected outer members; and,
a plurality of inner members, some of said plurality of inner members are connected to some of said plurality of outer members and some of said plurality of inner members are connected to some of said plurality of inner members;
at least one masts extending from said proximal surface of said platform, said mast having a jib arm moveably secured thereto; and,
a set of wheels secured to said platform.

11. The jib crane cart assembly recited in claim 10, wherein said set of wheels are arranged for a cart track of a coke oven battery.

12. The jib crane cart assembly recited in claim 10, wherein said mast is supported by a supporting member extending from said platform.

13. The jib crane cart assembly recited in claim 10 further comprising a second mast extending from said proximal surface of said platform, said second mast arranged distally in relation to said at least one mast, said second mast having a jib arm moveably secured thereto.

14. The jib crane cart assembly recited in claim 11, wherein some wheels of said set of wheels includes a first flange and some wheels of said set of wheels include a second flange, said second flange being unaligned with said first flange, wherein said first flanges and said second flanges are arranged to contact said cart track.

15. The jib crane cart assembly recited in claim 13, wherein said each jib arm includes a hoist displaceably attached thereto.

16. The jib crane cart assembly recited in claim 10, wherein said proximal surface of said platform includes at least one floor member arranged thereon.

17. The jib crane cart assembly recited in claim 13, wherein each of said jib arms are hingedly connected to each of said pair of masts.

18. A jib crane cart assembly, comprising:
a platform having a proximal surface and a distal surface, said platform having a reinforcement structure between said proximal surface and said distal surface, said reinforcement structure includes:
a plurality of connected outer members; and,
a plurality of inner members, some of said plurality of inner members are connected to some of said plurality of outer members and some of said plurality of inner members are connected to some of said plurality of inner members;
a first mast extending from said proximal surface of said platform, said first mast having a jib arm moveably secured thereto, said jib arm having a first hoist displaceably attached thereto;
a second mast extending from said proximal surface of said platform, said second mast having a jib arm moveably secured thereto, said jib arm of said second mast having a second hoist displaceably attached thereto; and,
a set of wheels secured to said platform.

19. The jib crane cart assembly recited in claim 18, wherein said set of wheels are arranged for a cart track of a coke oven battery.

20. The jib crane cart assembly recited in claim 18 further comprising at least one counterweight secured to said proximal surface of said platform and at least one floor member secured to said proximal surface of said platform.
